(19) United States
(12) Patent Application Publication
(10) Pub. No.: US 2005/0132215 A1
(43) Pub. Date: Jun. 16, 2005

(54) Dynamic delegation method and device using the same

(76) Inventors: Chung-Ren Wang, Tainan City (TW); Chih-Wei Yang, Rende Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/804,415

(22) Filed: Mar. 19, 2004

(30) Foreign Application Priority Data
Dec. 11, 2003 (TW) 92134995

(51) Int. Cl. H04L 9/32

(52) U.S. Cl. 713/200

(57) ABSTRACT

A dynamic delegation method. First, a set of delegation policies are provided as general rules for limiting delegation. Next, two kinds of data are received, including a delegation condition and a delegation approval submitted by a grantor for vesting authority of the grantor's role to a grantee, wherein the grantor's role is granted the authority to access a set of data. Next, consequent authority actually vested to the grantee is determined based on the delegation approval, the delegation condition and the delegation policies.

### BACKGROUND OF THE INVENTION

1. Field of the Invention

The present invention relates to a role-based data sharing delegation method, and in particular to a delegation method by which relegated authority is determined in accordance with static and dynamic. (contextual) conditions.

2. Description of the Related Art

In brief, data sharing means a user grants or receives authority to access a set of data from another user. Conventionally, a grantee communicates with a grantor to share grantor's data. Data sharing policies are provided for data security and legality. Private communication for data sharing, however, may not be controlled by data sharing policies and hence may lead to abuse of the vested authority or the data.

Additionally, a security officer supervises and manages all data sharing tasks. One or more persons serve as the security officer to deal with all data sharing requests. All grantees must communicate with the security officer for data sharing clearance. Because the security officer is responsible for all data sharing tasks, there is a probability that clearance may be granted to an unauthorized user. Without automation, data sharing is limited by the working hours of the security officer, and cannot on demand.

The role-based system is a data management system for grouping data access permission according to roles. Role-based access control 96 (RBAC96) model such as RDM2000 has become popular recently. In the method, a role-based system is used to manage data sharing. This method provides automatic data sharing management to address the problem of manpower. The grantor, however, doesn't have authority to tailor the vested authority and, hence, can't manage risk due to delegation.

The mobile environment has grown steadily, resulting in a growing need for data sharing. Hence, there is a need for a secure and flexible delegation method ameliorating the problems of the conventional method.

### SUMMARY OF THE INVENTION

Accordingly, an object of the invention is to provide a delegation method to solve the problem wherein the grantor lacks the authority to tailor the vested authority.

According to the object of the invention, the invention provides a dynamic delegation method. First, a set of delegation policies is provided as general rules for limiting delegation. Next, two kinds of data are received, including delegation condition and a delegation approval submitted by a grantor for vesting authority of the grantor's role to a grantee, wherein the grantor's role is given the authority to access a set of data. Next, consequent authority actually vested to the grantee is determined based on the delegation approval, the delegation condition and the delegation policies.

The delegation method may be implemented by a program recorded in a storage medium such as memory or memory device which, when loaded into a delegation device, directs the delegation device to execute the delegation method.

Another object of the invention is to provide a dynamic delegation device comprising a memory, a receiving unit and a processing unit. The memory stores delegation policies as general rules for limiting delegation. The receiving unit receives a delegation condition and a delegation approval submitted by a grantor for vesting authority of the grantor's role to a grantee, wherein the grantor's role is given the authority to access a set of data. The processing unit coupled with the memory and the receiving unit determines consequent authority vested to the grantee based on the delegation approval, the delegation condition and the delegation policies.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a configuration block diagram of a dynamic delegation device according to the preferred embodiment of the invention;

FIG. 2 is a relationship tree according to the preferred embodiment of the invention showing the hierarchical relationship between roles;

FIG. 3 is a flowchart showing the dynamic delegation method according to the preferred embodiment of the invention; and

FIG. 4 is an example of the delegation XML document according to the preferred embodiment of the invention.

### DETAILED DESCRIPTION OF THE INVENTION

The invention provides a dynamic delegation method ameliorating the problems where the grantor lacks the authority to tailor the vested authority.

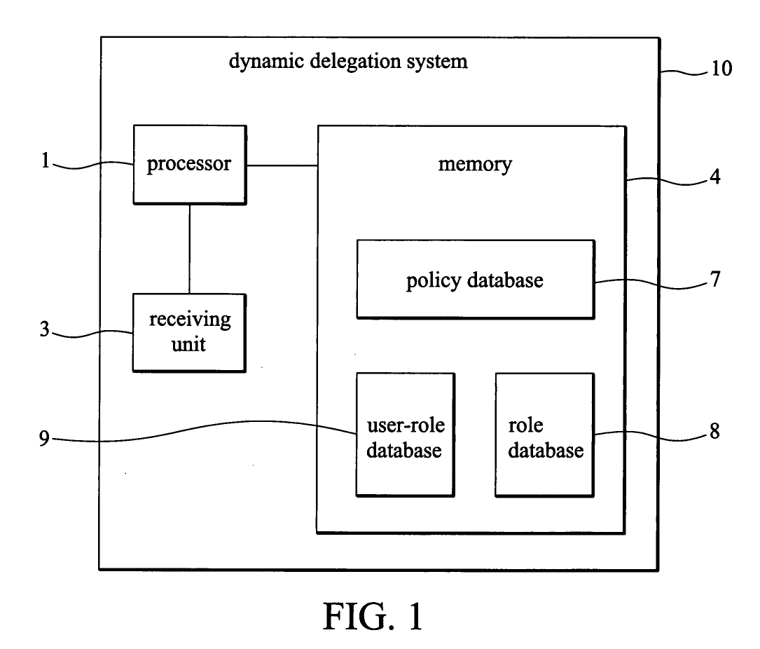

FIG. 1 shows a configuration block diagram of a dynamic delegation device according to the preferred embodiment of the invention. The combination of the dynamic delegation device and role-based system forms the dynamic delegation system 10. The dynamic delegation device comprises processor 1, input unit 3 and memory 4. The processor 1 is coupled to the input unit 3 and memory 4. The memory 4 stores a role-based system (not shown).

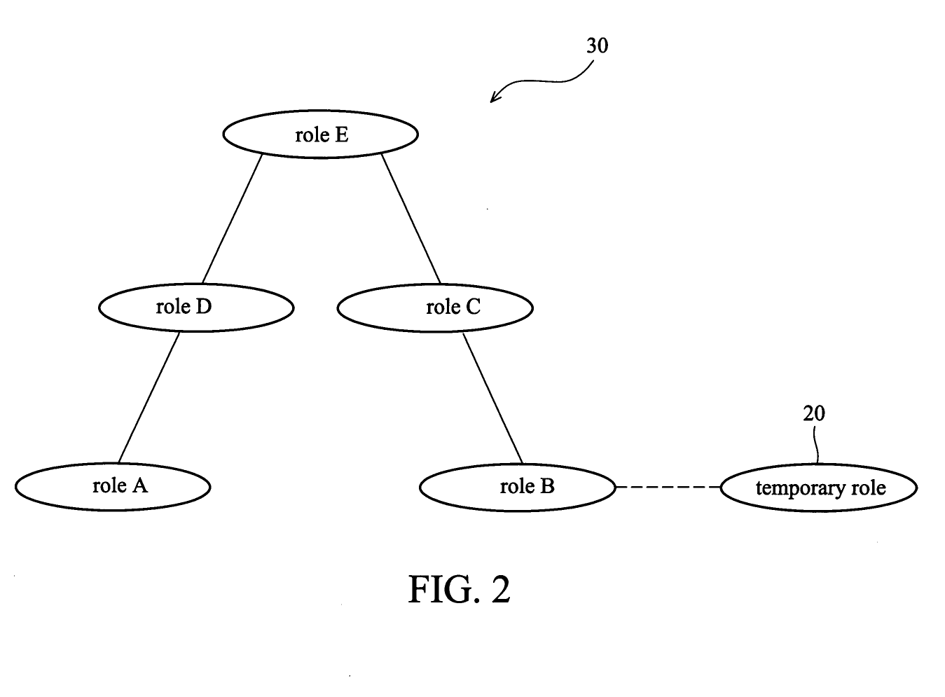

The memory 4 further stores a policy database 7, a role database 8 and a user-role database 9. The role database 8 storing a plurality of roles commensurate with respective authorities for respective sets of data is managed by the role-based system. A hierarchical relationship exists between roles. FIG. 2 is a relationship tree 30 showing the hierarchical relationship between roles, wherein each node represents a role and each edge represents a relationship between roles. In one relationship, the lower role is dominant to the upper role, for example, role A is dominant to role D, and role D is dominant to role E.

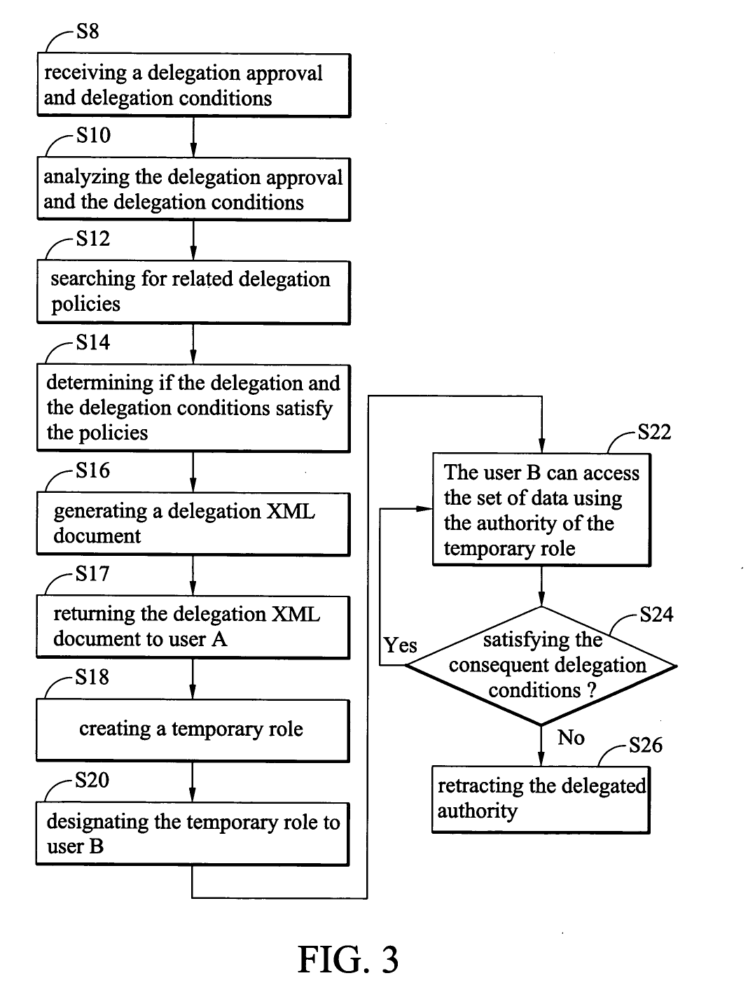

FIG. 3 is a flowchart showing the dynamic delegation method according to the preferred embodiment of the invention. The role-based system designates the role A to a user A and role B to user B and stores these relationships in the user-role database 9. When user B as a grantee requests user A as a grantor to delegate authority for data sharing, the user A submits delegation approval to the dynamic delegation system 10. In the present embodiment, the user A can limit the delegated authority with delegation conditions when submitting delegation approval.

The delegation conditions include static conditions and dynamic conditions. The static conditions include total time, location and function (operation) conditions regarding the authority. The dynamic conditions include session condition of the authority and group condition of grantee.

The total time condition limits the total time allowed for using the delegated authority. The location limits where the grantee is able to use the delegated authority. The function condition limits which function or operation the grantee is permitted to perform. The session condition limits which period of time the grantee is permitted to use the delegated authority, such as, for example, working hours or weekdays. The group condition limits which working groups are permitted to use the delegated authority, for example, as a member of a research group of a project, the grantee is permitted to use the delegated authority in the research group.

As much as a working group membership may change, so does the scope limited by a group condition. The session condition may refer to changing sessions. For example, when the session condition is “working hours”, the working hours differ between weekdays and weekend and may differ by appointment of personnel or by other factors. These kinds of conditions are defined as dynamic conditions, as they change according to dynamic variables, such as over time or are generated by derivation. The static conditions are static parameters decided by the grantor before delegation approval is submitted. In summary, dynamic conditions are variable and static conditions are constant. Hence, when using the static conditions, the dynamic delegation system 10 needs not to compute the actual scope of static conditions but simply refers to them.

In the embodiment of the present invention, delegation means that the grantor vests the authority of his role to a user as the grantee. A role corresponds to an authority for a set of data, so a user designated with a role is granted authority thereof. The role-based delegation of the invention is well-suited for any role-based system.

In this embodiment, the delegation approval and the delegation condition are represented as an extensible markup language (XML) document. A delegation approval XML document includes at least the following data, grantor role and grantee, static condition and dynamic condition, which are tagged with XML tags for delegation system 10 to analyze.

In the aspect of the dynamic delegation system 10, the processor 1 receives the delegation approval XML document and delegation condition of user A through the input unit 3 (step S8). The processor 1 analyzes the delegation approval XML document and acquires the delegation condition (step S10).

The processor 1 searches policy database 7 for related policies (step S12), determines if the delegation and the delegation conditions satisfy the policies and generates consequent conditions (step S14). In the determination process, the resultant delegated authority is the authority of the grantor role limited by the delegation conditions and the policies. For example, the following steps generate the resultant delegated authority. First, each of the delegation conditions is checked against policies. Next, any discontent is adjusted to conform to policies. Finally, the satisfying conditions and adjusted conditions are acquired as consequent conditions.

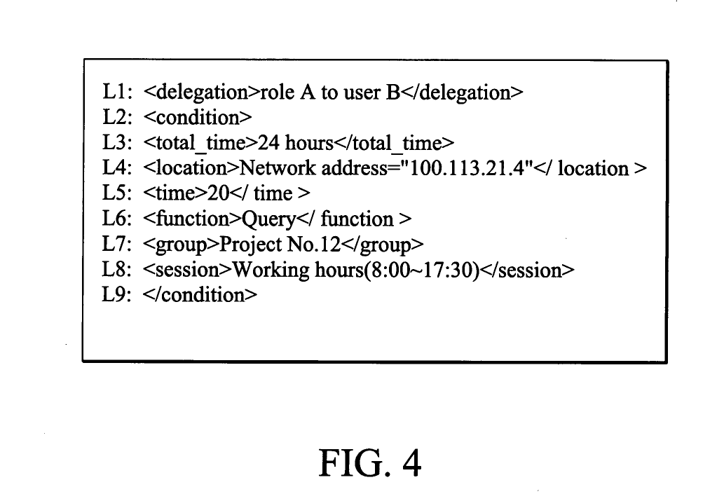

When the determination process is completed, the processor 1 generates a delegation XML document (step S16) and returns the delegation XML document to user A (step S17). The delegation XML document includes all information related to the resultant delegated authority. The related information includes grantor role, grantee and the consequent delegation conditions. The consequent delegation conditions comprise static and dynamic limits, and consequent authority delegated to user B. FIG. 4 is an example of the delegation XML document. The grantor role, the grantee and the consequent delegation conditions described therein such as total time, time, location, function, session and group are tagged with XML tags. Hence, the delegation XML document, similar to an approval XML document, also comprises information of grantor role, the grantee, consequent static conditions and consequent dynamic conditions. The dynamic delegation system 10 returns the delegation XML document to the grantor as a report after the determination process.

The processor 1 creates a temporary role in the role database 8 using the role-based system according to the information within the delegation XML document (step S18). The authority described in the delegation information and consequently delegated to user B comprises temporary role authority for the set of data, which is limited by the consequent delegation conditions. The processor 1 designates the temporary role to user B (step S20), where the temporary role is located at the same level as role B in hierarchical relationship. As shown in FIG. 2, the dotted line represents a new added relationship representing that the temporary role parallels role B, i.e. the temporary role is located at the same level as role B in the hierarchical relationship.

The user B can access the set of data using the authority of the temporary role, which is consequently delegated to user B (step S22). When user B accesses the set of the data, processor 1 determines if the access satisfies the consequent delegation conditions (step S24). If the access does not satisfy the consequent delegation conditions, processor 1 removes the delegation. The processor 1 then deletes the temporary role from the role database 8 to countermand the authority delegated to user B (step S26).

For example, the consequent delegation conditions limit the total time for using the authority of the temporary role to 24 hours, location condition limits the grantee access to a computer with the network address “100.113.21.4”, time condition limit usage of delegated authority to 20 times, function condition limits the grantee to query function, group condition limits the grantee to 12^{th} project membership, and session condition limits the grantee to working hours. The grantee breaks the consequent delegation condition whenever any violations of the consequent delegation conditions occur, such as using the authority of the temporary role for more than 24 hours, accessing the set of data using a computer with network address other than “100.113.21.4”, exceeding the delegated 20 time use limit, running functions other than query, accessing 12^{th} project membership data when no longer a member, or using the set of data outside working hours. When the user B uses the delegated authority and violates the consequent delegation conditions, processor 1 deletes the temporary role in the role database 8 to retract the authority delegated to user B.

In the preferred embodiment of the invention, the purpose of providing the approval document and delegation XML document in XML format is for analyzability by a computer program, which can be implemented in other data formats. Additionally, the authority delegated by user A to user B is recorded in the delegation document, so, if any user requests user A for delegation, processor 1 can directly designate the temporary role to the user to vest authority instead of re-performing the similar authority determination process described above.

In the preferred embodiment of the invention, although the information such as grantor role or grantee within an approval document or a delegation document is recited, other information such as a grantor can be recorded therein. In the case of a grantor recorded in an approval document or a delegation document, the processor 1 acquires a grantor role based on user-role database 9.

The dynamic delegation system according to the invention estimates and verifies delegation based on delegation policies as general rules, which provides identical protection for delegation and data sharing. In addition, delegation conditions defined by grantor increase delegation flexibility, facilitate fitting delegation in aspects of location, hours and data and enhance delegation security to retard delegated authority abuse of the grantee. Furthermore, the dynamic delegation method of the invention as a role-based delegation method is suitable for implementation in role-based systems.

The delegation method may be implemented by a program recorded in a storage medium such as memory or memory device which, when loaded into a delegation device, directs the delegation device to execute the delegation method.

The delegation method of the invention enables the grantor to define delegation conditions and, hence, ameliorates the problems of the conventional methods.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A delegation method, implemented in a delegation system, comprising the steps of:
providing delegation policies as general rules for limiting delegation;
receiving a delegation condition and a delegation approval submitted by a grantor for vesting authority of the grantor's role to a grantee, wherein the grantor's role is designated the authority to access a set of data; and
determining consequent authority vested to the grantee based on the delegation approval, the delegation condition and the delegation policies.

2. The method as claimed in claim 1, wherein the delegation condition is presented in extensible markup language (XML).

3. The method as claimed in claim 1, wherein the delegation condition comprises a static condition for limiting the vested authority.

4. The method as claimed in claim 3, wherein the static condition comprises at least a total time condition, a time condition, a location condition or a function condition.

5. The method as claimed in claim 1, wherein the delegation condition comprises a dynamic condition for limiting the vested authority.

6. The method as claimed in claim 5, wherein the dynamic condition comprises at least a session condition or a group condition.

7. The method as claimed in claim 1, further comprising the steps of:
storing the vested consequent authority as consequent delegation information;
creating a temporary role according to the consequent delegation information using a role-based system; and
designating the temporary role to the grantee.

8. The method as claimed in claim 1, wherein the determining step further comprises the steps of:
determining whether the delegation condition satisfies the delegation policies;
adjusting the delegation condition to the delegation policies when the delegation condition does not satisfy the delegation policies; and
acquiring a consequent delegation condition, where the consequent delegation condition comprises, when the delegation condition does not satisfy the delegation policies, the adjusted delegation condition or, when the delegation condition satisfies the delegation policies, comprises the delegation condition.

9. The method as claimed in claim 8, further comprising the steps of:
determining whether usage of the set of data satisfies the consequent delegation condition; and
retracting the vested authority when usage of the set of data does not satisfy the consequent delegation condition.

10. A delegation device, comprising:
a memory storing delegation policies as general rules for limiting delegation;
a receiving unit for receiving a delegation condition and a delegation approval submitted by a grantor for vesting authority of the grantor's role to a grantee, wherein the grantor's role is designated the authority to access a set of data; and
a processing unit for determining consequent authority vested to the grantee based on the delegation approval, the delegation condition and the delegation policies.

11. The device as claimed in claim 10, wherein the delegation condition comprises a static condition for limiting the vested authority.

12. The device as claimed in claim 10, wherein the delegation condition comprises a dynamic condition for limiting the vested authority.

13. The device as claimed in claim 10, wherein the processing unit further determines whether the delegation condition satisfies the delegation policies, adjusts the delegation condition to the delegation policies when the delegation condition does not satisfy the delegation policies, and acquires a consequent delegation condition, where the consequent delegation condition comprises, when the delegation condition does not satisfy the delegation policies, the adjusted delegation condition or, when the delegation condition satisfies the delegation policies, comprises the delegation condition.

14. The device as claimed in claim 13, wherein the processing unit further determines whether usage of the set of data satisfies the consequent delegation condition, and retracting the vested authority when usage of the set of data does not satisfy the consequent delegation condition.

15. A machine-readable storage medium storing a computer program which, when executed, directs a computer to perform a delegation method, comprising the steps of:
receiving a delegation condition and a delegation approval submitted by a grantor for vesting authority of the grantor's role to a grantee, wherein the grantor's role is designated the authority to access a set of data;
reading delegation policies as general rules for limiting delegation; and
determining consequent authority vested to the grantee based on the delegation approval, the delegation condition and the delegation policies.

16. The machine-readable storage medium as claimed in claim 15, wherein the delegation condition comprises a static condition for limiting the vested authority.

17. The machine-readable storage medium as claimed in claim 15, wherein the delegation condition comprises a dynamic condition for limiting the vested authority.

18. The machine-readable storage medium as claimed in claim 15, wherein the delegation method further comprises the steps of:
storing the vested consequent authority as consequent delegation information;
creating a temporary role according to the consequent delegation information using a role-based system; and
designating the temporary role to the grantee.

19. The machine-readable storage medium as claimed in claim 15, wherein the determining step further comprises the steps of:
determining whether the delegation condition satisfies the delegation policies;
adjusting the delegation condition to the delegation policies when the delegation condition does not satisfy the delegation policies; and
generating a consequent delegation condition, where the consequent delegation condition comprises, when the delegation condition does not satisfy the delegation policies, the adjusted delegation condition or, when the delegation condition satisfies the delegation policies, comprises the delegation condition.

20. The machine-readable storage medium as claimed in claim 19, wherein the delegation method further comprises the steps of:
determining whether usage of the set of data satisfies the consequent delegation condition; and
retracting the vested authority when usage of the set of data does not satisfy the consequent delegation condition.
